(19) United States
(12) Patent Application Publication
(10) Pub. No.: US 2017/0008114 A1
(43) Pub. Date: Jan. 12, 2017

(54) SYSTEM AND METHOD OF CONTROLLING ATTACHMENT AND RELEASE OF ADDITIVE MANUFACTURING BUILDS USING A WELDING PROCESS

(71) Applicant: Lincoln Global, Inc., City of Industry, CA (US)

(72) Inventors: Daniel J. Langham, Valley City, OH (US); David A. Harrison, Middlefield, OH (US)

(21) Appl. No.: 14/795,284

(22) Filed: Jul. 9, 2015

(51) Int. Cl. B23K 9/04; B23K 9/10

(52) U.S. Cl. CPC B23K 9/04; B23K 9/1043

(57) ABSTRACT

A system and method is provided related to additive manufacturing, where a welding system is used to build a work piece on a substrate where the work piece has discrete attachment points to the substrate to allow residual stresses in the finished work piece to aid in the removal of the work piece from the substrate. The work piece has one or more discrete attachment points which penetrate into the substrate to secure the work piece during manufacture, but which allow the residual stress in the completed work piece to aid in the removal of the work piece from the substrate.

### BACKGROUND OF THE INVENTION

Field of the Invention

Systems and methods of the present invention relate to additive manufacturing, and more specifically to controlling the attachment and release of a work piece from a substrate after an additive manufacturing process is used to construct the work piece.

Description of the Related Art

Processes and systems for additive manufacturing are being developed and can be used to construct any number of different types and shapes of work pieces. In some of such processes, a metallic material is placed in layers on a substrate to build up the desired work piece, using a process such as a MIG or TIG welding process. After the build is complete the work piece is removed from its substrate and can be machined or finished to achieve the desired work piece. However, with such processes the work piece is fully bonded to the substrate and has to be machined from the substrate to be removed. This process is time consuming and can result in damage to work piece. It is desirable to avoid these issues when using additive manufacturing to build metallic work pieces.

Further limitations and disadvantages of conventional, traditional, and proposed approaches will become apparent to one of skill in the art, through comparison of such approaches with embodiments of the present invention as set forth in the remainder of the present application with reference to the drawings.

### BRIEF SUMMARY OF THE INVENTION

Embodiments of the present invention include equipment and methods related to additive manufacturing, where a welding system is used to build a work piece on a substrate where the work piece has discrete attachment points to the substrate to allow residual stresses in the finished work piece to aid in the removal of the work piece from the substrate. The work piece has one or more discrete attachment points which penetrate into the substrate to secure the work piece during manufacture, but which allow the residual stress in the completed work piece to aid in the removal of the work piece from the substrate.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of a an exemplary embodiment of an additive manufacturing system of the present invention;

FIG. 2 is a diagrammatical representation of an additive manufacturing process where a work piece is fully secured to the substrate;

FIGS. 3A to 3D are diagrammatical representations of an exemplary additive manufacturing process of the present invention;

FIG. 4 is a diagrammatical representation of an exemplary flow chart for a manufacturing process of the present invention;

FIGS. 5A to 5C are diagrammatical representations of exemplary first layers which can be created with exemplary embodiments of the present invention; and

FIGS. 6A and 6B are exemplary current waveforms which can be used with exemplary embodiments of the present invention.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

It is noted that for purposes of the following discussion, the system will be discussed as metal inert gas (MIG) welding system. However, exemplary embodiments are not limited using such arc welding systems, and embodiments can use other welding methods, such as TIG, pulse arc, short arc, surface tension transfer, etc.

Because the manufacture, assembly and use of arc welding power supplies and systems are known to those of skill in the art, they will not be discussed in detail herein.

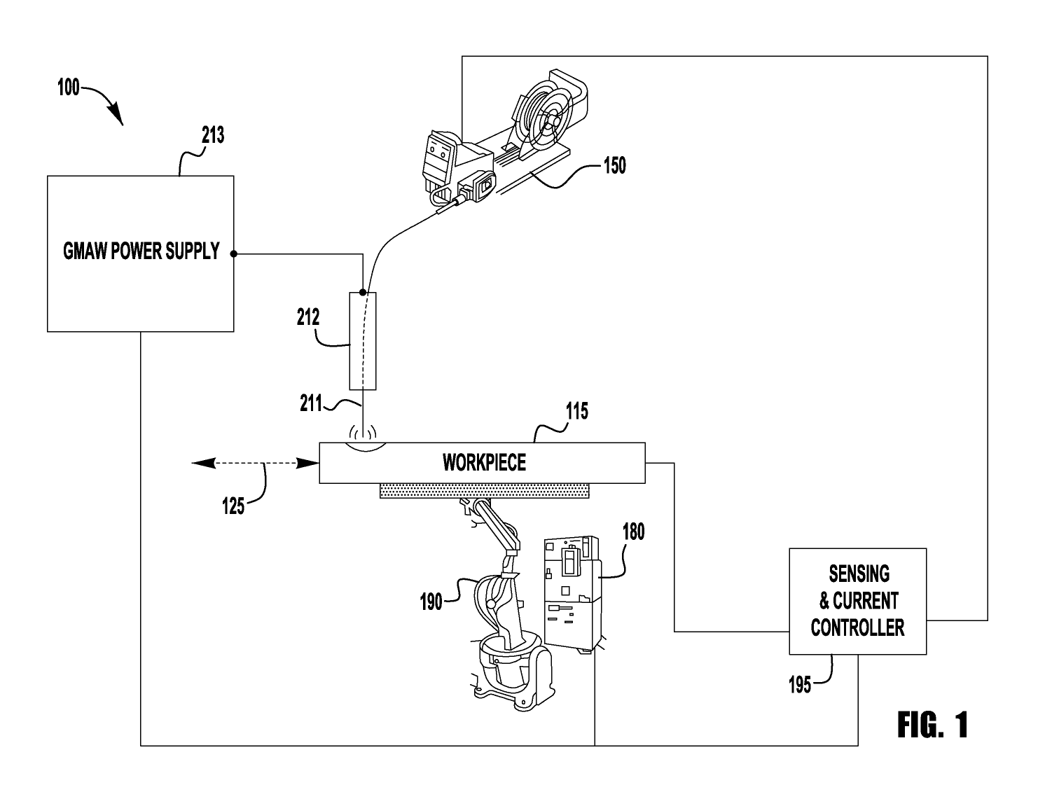

Turning now to FIG. 1, an exemplary embodiment of an additive manufacturing system 100 of the present invention is shown. As an initial matter, it should be noted that the system 100 can be constructed similar to any known additive manufacturing/welding system which is used to deposit a consumable to create a work piece and/or weld. Further, while embodiments of the present invention are directed to additive manufacturing—using arc welding processes—systems which are similarly constructed to arc welding systems can be used. For example, as shown the system 100 contains an arc welding power supply 213 which is capable of creating an arc between an electrode and a work piece to deposit a consumable. While the power supply 213 is shown as a GMAW type power supply, any other type of arc welding power supply can also be used. For example, a TIG power supply can be used. Further, the power supply 213 can be constructed and operated like any known arc welding power supply. For example, the power supply 213 can use any of a transformer and/or inverter structure to convert utility or generator input power to an output signal that is suitable for an additive manufacturing process. In exemplary embodiments, the output signal from the power supply 213 used for arc based additive manufacturing process is similar to known output signals used for arc welding processes, and can include known MIG, TIG, pulse, and STT processes, as well as others.

The power supply 213 is coupled to a contact tip 212, which can be in either a handheld or robotically held torch (not shown), so that the output signal from the power supply 213 is delivered to the electrode 211. Because the process shown is a MIG process, in FIG. 1 the electrode 211 is also the consumable of the process which is deposited and used to create the work piece 115. The electrode/consumable 211 can be any suitable consumable for the desired process and work piece to be constructed. For example, the electrode 211 can be any known MIG wire. Further, in systems which use a TIG process, the consumable 211 can be any known TIG consumable. Of course, it is noted that if a TIG process is used the electrode and the consumable 211 are separate and distinct.

As shown, the consumable/wire 211 can be delivered from a wire feeder 150. The wire feeder 150 can be similar to any known wire feeder device. Not shown in a shielding gas tank/system. However, such systems are widely known and their structure, operation and function need not be described herein. Further, the system 100 can include a robotic/motion system 190 which is capable of moving the work piece 115 and/or the torch/contact tip 212 during the build operation. The motion system 190 can be any known type of motion system, such as a robotic system, a semi-automatic system, a table based system, etc. The motion system 190 can move the work piece in multiple directions (see, e.g. 125) so as to all the build of the work piece 115 to proceed as desired, and can be coupled to a motion system controller 180.

Further, the system 100 includes a controller 195 which is used to control the overall operation and process of the system 100. It is noted that although the controller 195 is shown separately from the power supply 213 and motion system controller 180, embodiments of the present invention can have the controller 195 internal to any one of the components of the system 100. The controller 195 can be any computer/processor based system which is capable of controlling the operation and use of the system 100 to build the desired work pieces 115. The controller 195 can have a memory storage for storing data and build programs, and is capable of receiving user input and feedback data from the process to control the overall operation of the system 100. Such controllers 195 and their function are known in robotic and semi-automatic welding processes, and need not be described in detail herein.

Because the operation of the system 100 for an additive manufacturing process is similar to that of an arc welding process, the details of the operation of the system 100 need not be set forth herein. Those of skill in the art will be able to utilize the system 100 (and other arc welding/building systems) consistent with the information and explanations set forth herein.

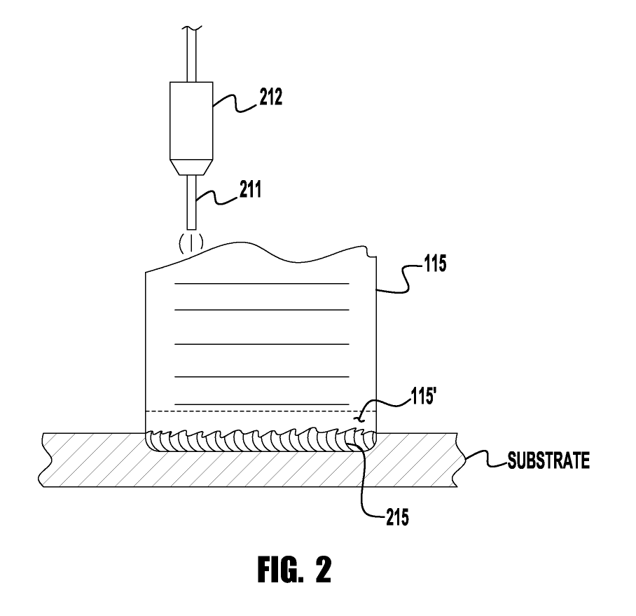

Turning now to FIG. 2, a work piece 115 that has been constructed using a traditional methodology is shown. Specifically, the work piece 115 is constructed by adding multiple layers of the consumable 211 being deposited via an arc welding process. When an additive build takes place as shown in FIG. 2 a first layer 115′ is deposited onto the substrate or support used for the build process, where the first layer 115′ is formed using a normal arc welding process. Because of this, the first layer 115′ penetrates the substrate, creating a bonding region 215 with the substrate. This bonding region 215 covers the entire contact area between the bottom of the work piece 115 and the substrate. That is, during the creation of the first layer 115′ the arc welding process penetrates the substrate through the creation of the entire first layer 115′. After this first layer 115′ is created, the additive manufacturing process continues and subsequent layers are built onto the first layer 115′. However, at the completion of the work piece 115 the work piece 115 must be removed from the substrate. This requires the work piece being cut or machined from the substrate. This process can be time consuming and can result in damage to the work piece 115. Further, in many instances the substrate cannot be reused after the manufacture of the work piece 115. Therefore, it is desirable to improve this process as described herein.

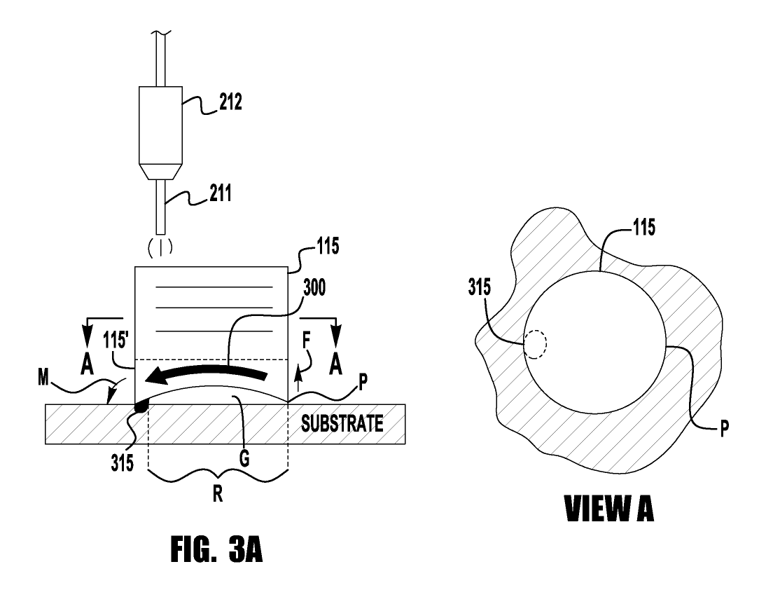

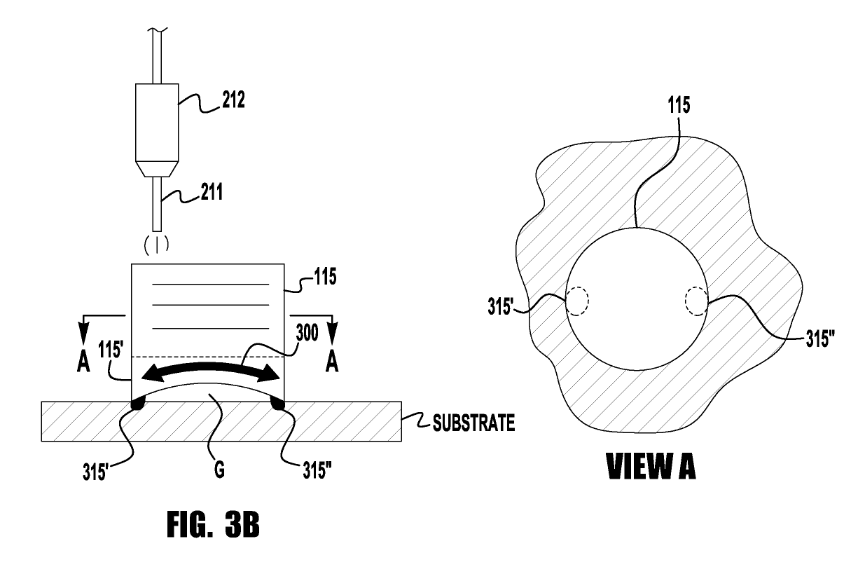

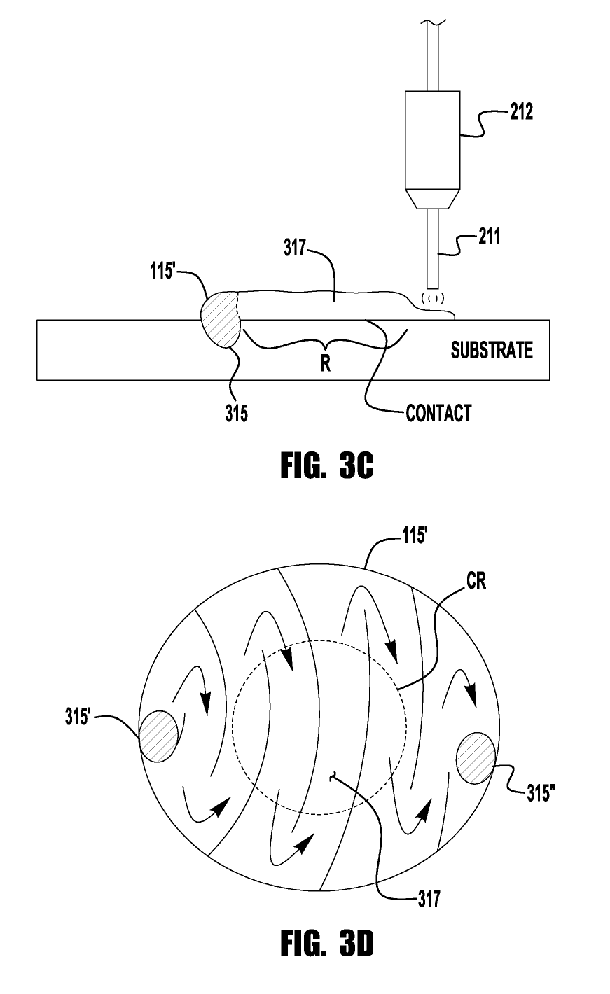

As shown in FIGS. 3A to 3D, embodiments of the present invention build the work piece 115 on the substrate with limited attachment between the work piece and the substrate. Specifically, systems and methods of the present invention deposit the first layer 115′ of the work piece 115′ with at least one discrete attachment point 315 which penetrates the substrate, while the remainder of the first layer 115′ is deposited such that there is no bonding or fusion between the layer 115′ and the substrate. Further, the discrete attachment points 315 are selected such that the residual stresses present in the work piece 115 after the completion of the work piece 115 aid in the removal of the work piece 115 from the substrate.

It is generally known that the welds and deposits created by an arc welding process can have internal residual stresses due to, at least, the cooling/shrinking of the deposited material. In some applications, these internal stresses and stress patterns can result in the deformation and/or deflection of the deposit/weld/work piece upon completion. Typically, this deformation is undesirable and can adversely affect the shape of a finished work piece. However, embodiments of the present invention take advantage of these internal stresses and use these stresses to aid in the easy separation of the work piece from the substrate. Embodiments of the present invention accomplish this by varying the heat input and/or other deposition parameters when the initial layer 115′ is created so that only discrete portions of the work piece 115 are bonded to the substrate and where the internal residual stress patterns are developed so that they aid in the removal of the work piece from the substrate. This will be discussed in more detail below.

A representative work piece 115 is shown in FIG. 3A which has been made in accordance with an embodiment of the present invention. As shown in FIG. 3A, the first layer 115′ of the work piece 115 is secured to the substrate at point 315, at which the process penetrates into the substrate so that there is some bonding between the substrate and the layer 115′. This bonding acts to secure the work piece 115 to the substrate for the manufacturing process, and ensures that the work piece remains stable during the remainder of the process. Further, as shown, the remainder of the first layer 115′ is deposited onto the substrate in a region R where the layer 115′ does not bond or otherwise fuse to the substrate. In the creation of this region R the power supply uses a deposition process having a heat input level which is less than the heat input level used to create the point 315. Because of this lower level the layer 115′ does not bond or fuse to the substrate within the region, which makes the removal of the finished work piece easier. Additionally, the work piece 115 is constructed such that the internal stresses 300 deform the work piece in such a way as to aid in the removal process. Specifically, the residual stresses 300 in the work piece 115 can cause portions of the work piece 115 to deform such that a gap G is formed between the work piece 115 and the substrate. Moreover, the stresses 300 can deform the work piece 115 such that a point P of the layer 115′ which is remote from bonding point 315 makes contact with the surface of the substrate such that a force F is imparted onto the work piece, where the force F imparts a moment M on the bonding point 315. This force F and moment M subsequently aid a user in removing the work piece 115 from the substrate. Because of this aspect of the present invention, a user can remove the work piece with little force on the work piece 115. This eliminates the need to use extensive, and potentially damaging, machining or cutting operations. Moreover, only a discrete portion of the substrate is damaged during the operation and can be used again. It should be noted that the discussions herein referencing “heat input” are referring to the average heat input of the specific aspect of the process being discussed.

FIG. 3B depicts another exemplary embodiment of the present invention where the layer 115′ has two bonding points 315′ and 315″. In such embodiments, the residual stresses 300 (which can be either compression or tension forces) impart forces on each of the bond points 315′ and 315″ such that the breaking of the contact between the work piece 115 and the substrate can be made easier. Again, because of the residual stresses 300 in the work piece 115 and the patterning (e.g., direction) of the stresses a gap G can be created between portions of the layer 115′ and the substrate. Using this gap G, a user can easily remove the work piece from the substrate with minimal effort and force. Again, this is due to the fact that the residual stress patterns 300 within the work piece 115 are applying forces to the bond points 315′ and 315″ which aid in removing the work piece 115 from the substrate.

FIG. 3C depicts an exemplary embodiment of creating at least a portion of the first layer 115′. As shown, at the beginning of the deposition process (which can be started using any known arc starting process) the bond point 315 is created. This portion of the operation uses weld parameters (e.g., current, voltage, wire feed speed, heat input) which create a desired level of penetration into the substrate to structurally bond the layer 115′ to the substrate so that a stable connection is created. The level of bonding (i.e., fusion) between the substrate and layer 115′ is such that the work piece 115 is held in a stable state during the remainder of the construction of the work piece 115. The size and depth of penetration of the bond point 315 is selected to ensure that the proper fusion and contact is attained. Further, while it is shown herein that the bond point has a general circular cross-section, other embodiments can use other general shapes as well. For example, the bond point can be a line contact point, as well as having other shapes. After the bond point 315 is created, the power supply 213 changes its output to reduce the heat input of the deposition process such that the deposition bead 317 after the creation of the bond point does not fuse or bond to the surface of the substrate. Specifically, the power supply 213 changes any one, or a combination of, the current, wire feed speed, power, waveform, polarity and voltage of the waveform being supplied to the electrode such that the overall heat input of the deposition bead 317 is at a level where the deposited material contacts the substrate , but does not penetrate or bond to the surface of the substrate. This heat input level can be maintained for the deposition of the layer 115′ until the layer is completed or until an additional bond point is needed, at which time the heat input of the waveform is increased so as to create a second bond point. After the completion of the first layer 115′ subsequent layers of the work piece 115 are placed on the first layer 115′ until the work piece is completed. As will be explained below, the deposition of the subsequent layers can be used to create a desired internal residual stress pattern to optimize the internal stresses to aid in removing the work piece 115 from the substrate.

FIG. 3D is a top down view of the deposition of a first layer 115′ on a substrate. In this figure the layer 115′ has a generally circular shape, for a rod or cylinder type work piece. As shown in this exemplary embodiment, the creation of the first layer 115′ starts at a first bond point 315′. To create the first bond point, the power supply 213 outputs a deposition current signal that has a first level of heat input and uses a first wire feed speed. After the bond point 315′ is created, with the desired shape and penetration, the power supply switches to a second heat input level (by changing any one, or number, of output parameters) to deposit the deposition bead 317. The heat input level for the deposition bead is lower than the bond point heat input level and is selected so that the deposition bead 317 does not bond to the substrate. The deposition bead 317 is deposited in a desired pattern to achieve a desired shape for the first layer 115. In the embodiment shown in FIG. 3D, at the end of the deposition bead 317 a second bond point 315″ is created. The creation of the second bond point 315″ can use the same waveform/heat input as the first bond point 315′. Further, it should be noted that while the shown embodiment has bond points 315′/315″ at the beginning and end of the deposition bead 317, other embodiments are not limited to this. For example, as shown in FIG. 3A a single bond point 315 can be used. Alternatively, bond points can be created at different points along the creation of the deposition bead 317. For example, a bond point can be created at some point between the beginning and the end of the deposition bead 317. Further, while the embodiments discussed above discuss using one or two bond points, other embodiments of the present invention can utilize any number of bond points, as desired.

In the embodiment shown in FIG. 3D, the deposition bead 317 is shown being laid down in a back-and-forth pattern. The deposition pattern for the deposition bead 317 should be selected to create the desired residual stress patterns within the layer 115′ and the work piece 115 that will aid in the removal of the work piece from the substrate. That is, a deposition pattern can be selected for the first layer 115′ and/or additional layers to be deposited onto the first layer 115′ which create internal residual stresses which can cause the first layer 115′ to deform/deflect to create a gap G and impart forces on the bond points to allow for easy removal of the work piece.

In further exemplary embodiments, not only is the deposition pattern of the deposition bead controlled to achieve the desired residual stress patterns, but the deposition bead current/heat input can also controlled to achieve the desired residual stress patterns. In such embodiments, during the creation of the deposition bead 317 the power supply 213 changes the deposition current signal, during the creation of the deposition bead 317, to change the deposition process during a portion of the deposition bead process. These changes can be used to aid in the creation of a desired residual stress pattern in the work piece. For example, in an exemplary embodiment of the present invention, after a bond point 315 is created the deposition bead is started with first deposition bead heat input level. As stated above, this first deposition bead heat input level is lower than the heat input level used to create the bond point. After a first deposition bead period the deposition bead process changes from the first deposition bead heat input level to a second deposition bead heat input level, which is different than the heat input level of the first portion of the deposition bead process. In some embodiments the second deposition bead heat input level is higher than the first, while in others it is less. This change in heat input level, during the creation of the deposition bead 317, can be used to create a desired residual stress pattern in the layer 115′ and/or the work piece to create the desired forces on the bond points to aid in separation of the work piece 115.

For example, in an exemplary embodiment, as shown in FIG. 3D, to achieve a desired residual stress pattern, it may be desired to deposit a central region CR of the first layer 115′ at a different heat input level than the remainder of the first layer 115′. Therefore, during the deposition of the first layer 115′, as the bead 317 transitions from outside of the region CR into the region CR, the power supply changes to the second heat input level to create the desired bead profile. Of course, while the second heat input level is different than the first heat input level of the deposition bead 317, each of the heat input levels are below a fusion or bonding level so that the deposition bead 317 does not bond to the surface of the substrate. Of course, in other exemplary embodiments, additional heat input levels can be used can achieve the desired residual stress patterns.

As indicated above, the deposition bead heat input level is lower than that of the bond point heat input level, and the deposition bead input level(s) is below a level at which the layer 115′ will bond to the surface of the substrate. In exemplary embodiments, the deposition bead heat input level is in the range of 7 to 30% below the level of the heat input of the initial bond point. In other exemplary embodiments, the deposition bead heat input level is in the range of 10 to 20% below that of the bond point heat input level.

The power supply 213 can change the heat input during the deposition of the first layer 115′ by changing any one of, or any combination of, the arc current, power, voltage and consumable wire feed speed. This can be controlled by the controller 195 to achieve the desired deposition profile for the first layer 115′.

Once the first layer 115′ is deposited, any subsequent layers can be deposited onto the first layer 115′ using the desired deposition waveform. In some exemplary embodiments, the current waveform used to deposit subsequent layers can be the substantially the same as that used to create the bond points, for example having similar average heat input levels. In further exemplary embodiments, the subsequent layer deposition waveform can be different than the bond point waveform, but should provide for sufficient penetration into earlier layers to provide the desired structural integrity of the work piece 115. Additionally, the deposition pattern and deposition waveform of subsequent layers to the first layer 115′ should be selected to achieve the desired internal residual stresses used to aid in the separation of the work piece 115.

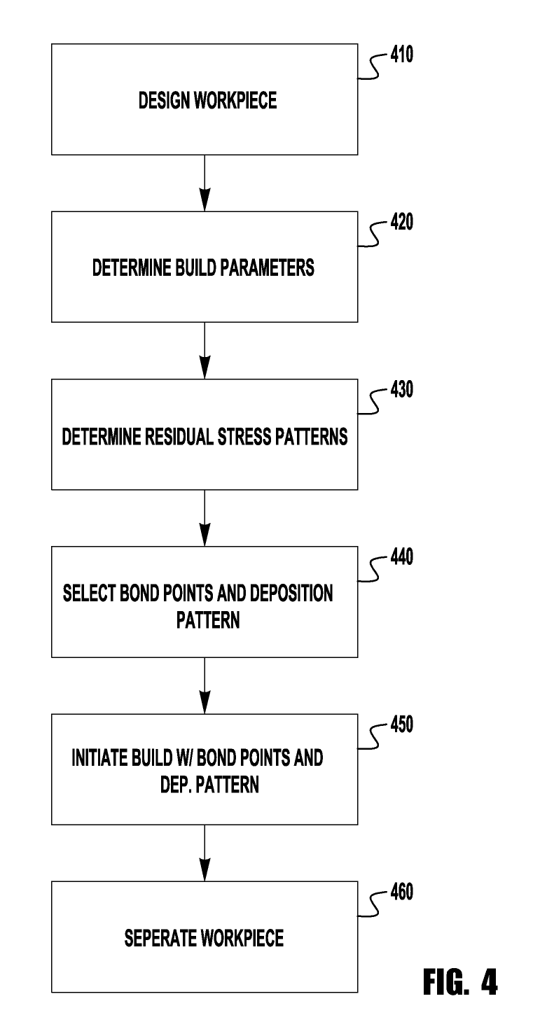

Turning now to FIG. 4, a flow chart for an exemplary process of the present invention is depicted. Initially, a work piece or part to be built is designed at 410. After the piece is designed, the parameter/process of the build are determined at step 420. During this phase, the process parameters of the build can be determined, including the power supply input parameters, including current, voltage, wire feed speed, waveform type, etc. for the build process. This can include the process parameters for each of the bond points, deposition bead of the first layer 115′, and the subsequent layers of the work piece 115. After the process/build parameters are determined, a desired residual stress pattern is determined at step 430. The residual stress pattern/profile is determined based on at least the shape of the work piece 115 and the first layer 115′ so as to allow for easy removal. For example, it can be determined that a desired residual stress pattern extends along a long length of the rectangular shaped first layer 115′. Based on this information, the bond points can be selected at 440. In this step, the depth, diameter, shape, number and location of the bond point(s) are determined. Further, the deposition pattern for the deposition bead 317 can be determined to achieve the desired stress profile. The above information can then be entered into the controller 195 and/or power supply 213 via a user interface, or any other known means. The controller 195 (which can be internal to the power supply 213) can be any type of known CNC type (or similar type) device which can control the operation of the system 100 to build the work piece 115 in accordance with the input information, including process and positional data. After the appropriate information has been entered into the controller 195, the process is initiated and begins to build the work piece 115 using the desired parameters. The process begins by creating the first bond point 315 the substrate, and then completes the process as designed in the steps above. After completion of the build, the residual stresses in the work piece 115 imparts forces on the bond point(s) such that the removal of the work piece 115 is made easier, and the work piece 115 can be removed. After removal, the work piece 115 can be machined or finished to a desired shape, as needed.

In the above described process, the process data for the creation of the bond points and the desired residual stress pattern(s) can be entered by a user into the controller 195 to control the operation of the system 100. However, in other exemplary embodiments, aspects of the bond point(s) and/or first layer deposition bead can be determined by the controller 195, based on user input data into the controller 195. For example, the controller 195 can use look up tables, state tables, preprogrammed data, etc., to automatically determine process parameters for the bond points and first layer of a work piece to be built. For example, the controller 195 can be pre-programmed for a number of different shape profiles for a first layer, and use this information, along with user input data, to automatically determine the bond point parameters and process parameters for the deposition bead. For example, the controller 195 can be preprogrammed with a number of area shapes for a first layer that can be commonly used for build processes. Such shapes can include circles, squares, rectangles, ellipses and any other geometric shapes that are anticipated to be used. For each of these shapes, the controller 195 (via a memory) contains preprogrammed information for each of these shapes related to a desired or optimized residual stress pattern and bond points, which can be based on any one, or any combination, of: the shape of the first layer, work piece material type, substrate material type, work piece mass, and first layer area (i.e., the area on the substrate surface that the first layer would occupy). Thus, in such embodiments a user can use a user interface (not shown) coupled to the controller 195, where the user enters any one of, or a combination of, a cross-sectional shape (i.e., footprint shape) of the first layer (e.g., circle, etc.), a material type for the work piece, a cross-sectional area—or dimensions (e.g., radius, etc.) of the cross-sectional shape of the first layer, and an anticipated mass of the work piece. Using this information, the controller 195 can use preprogrammed or stored information to determine the location and number of the bond points, the deposition patterning and the parameters (voltage, current, WFS, etc.) for the bond points and for the remainder of the deposition of the first layer. Further, the system 100 can have a memory/storage coupled to the controller 195 to allow work pieces to be stored in the memory so that they can be recalled when needed. Thus, embodiments of the present invention can automatically configure the power supply and select the operational parameters for the bond points and the remainder of the first layer based on user input information, based on preprogrammed and/or predicted internal residual stress patterns for the first layer. Additionally, the system 100 also allows for a user to input these parameters, etc. so that a user can identify the locations and operational parameters of the bond points and the patterning and parameters of the remainder of the first layer.

The following are exemplary parameters that can be, and have been, used to build an exemplary workpiece. Of course, these parameters are intended to be exemplary and are not intended to be applicable to all of the varying applications of multiple embodiments of the present invention. For example, in the building of a mild steel workpiece, using an 0.035″ dia. Consumable, a WFS of 90 in/min, a voltage of 14.5V and a travel speed of 3.4 in/min. can be used for the creation of the attachment point(s) as described herein. During a first pass overlapping the attachment point the WFS can be changed to 80 in/min, with a voltage of 15.5 V, while the travel speed can be unchanged. Then during an inset cover portion of the process the WFS can be sped up to about 95 to 100 in/min, with a voltage in the range of 14.5 to 15.0, and a faster travel speed of 4.4 in/min. Finally, the building of the remainder of the workpiece can be done with a WFS in the range of 80-125 in/min, with a voltage in the range of 14.5 to 18.5 V and a travel speed in the range of 3.4 to 4.5 in/min. With using these procedures, a workpiece can be built which has a discrete attachment point to a substrate and internal stresses that allow for the easy removal of the workpiece from the substrate, as described herein.

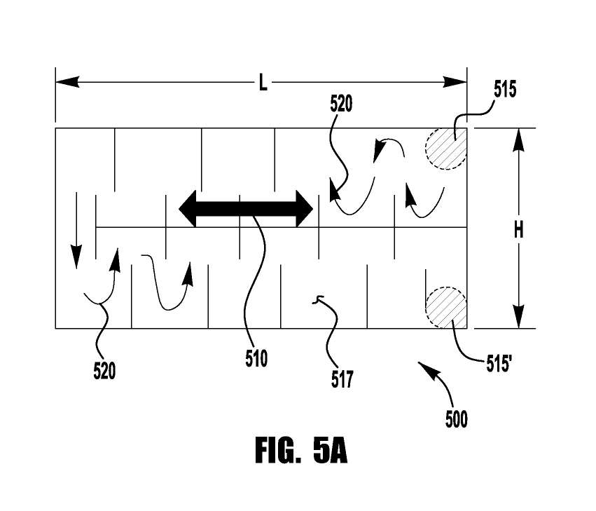

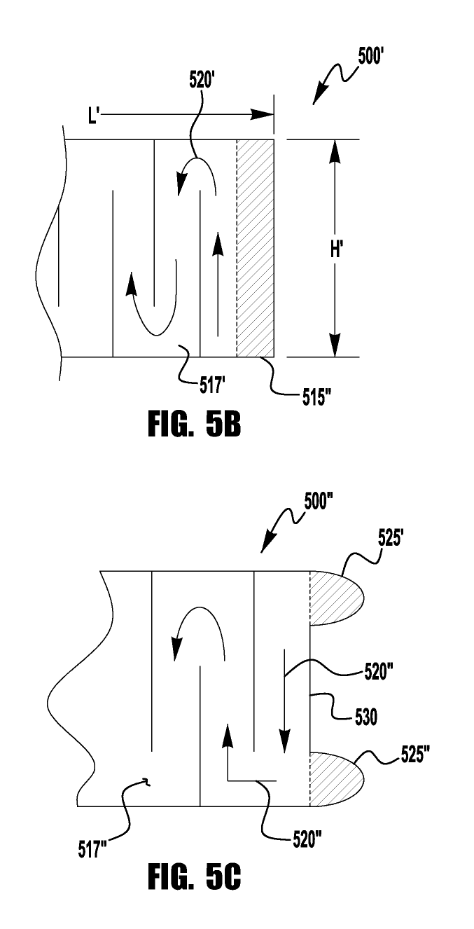

FIG. 5A depicts an exemplary first layer 500 of a work piece. The first layer 500 can be designed and planned by an operator of the system 100 based on the anticipated internal residual stresses 510, or can be determined by the controller 195 as described above, where the controller 195 builds the design and parameters of the first layer 500 based on user input, such as the height H and length L of the first layer 500, and that the layer is a rectangle. Further inputs can be material type and mass of the completed work piece, as well as others. As shown in this embodiment, the first layer 500 has two bond points 515 and 515′, positioned on the corners of the first layer 500 as shown. The bond points 515/515′ are discrete points, having a generally circular cross-section. Further, the deposition pattern of the first layer 500 is determined to follow the path 520 as shown, such that the deposition begins at bond point 515, follows path 520 to create the deposition bead 517 of the layer 500, and then ends at the second bond point 515′. As shown, this patterning (along with the deposition parameters used, such as current, WFS, etc.) results in a residual stress pattern 510 as shown. This internal residual stress pattern 510 results in a pattern that predominantly runs along the length L of the first layer (as shown) and thus adds stresses in each of the bond points 515/515′ which aids in the removal of the work piece from the substrate as described above.

FIG. 5B depicts another exemplary embodiment of a first layer 500′ where either the controller 195′ and/or the user determined that the bond point 515″ should be extended along the height H of the first layer 500′ as shown. Thus, in this embodiment, based on the design/input parameters of the work piece and/or layer, it was determined that a single bond point having a generally extended length (as opposed to a circular cross-section) is desirable. In this embodiment, the length of the bond point 515″ extends the entire height H of the first layer. However, in other embodiments, this need not be the case. Further, as shown, the deposition pattern 520′ is shown for the deposition bead 517′. Of course, in other embodiments the pattern 520 can be different, to achieve the desired internal residual stress patterns.

FIG. 5C depicts another exemplary embodiment of the present invention, where the bond points 525′ and 525″ are actually positioned outside of the desired perimeter 530 of the first layer 500″. In the embodiments shown above, the bond points are located within the outer perimeter of the intended shape of the first layer. Thus, when the work piece is removed from the substrate, the bond points (attachment points) need to be machined from the bottom of the first layer. The embodiment in FIG. 5C has the bond points 525′ and 525″ outside of the desired perimeter 530 of the first layer 500″ so that the they form tabs which can be removed from the work piece after the work piece is removed from the substrate. During deposition, the bond point 525′ is formed first and then the deposition follows the path 520″ until it reaches the second bond point 525″ at which time this bond point is created, and then the deposition is resumed along the path 520″. Such embodiments can be used when it is desired that the entire first layer of the work piece be deposited with the same operational parameters (i.e., current, WFS, etc.). that is, it is desired that the entire first layer be deposited using the same process. In such embodiments, the bond points—which use different process parameters as described above—can be removed after the process is completed.

As discussed above, and depicted in the figures, the bond points of the present invention represent a relative small amount of the overall area of the first layer. This aids in making the removal of the work piece easier from the substrate. In exemplary embodiments, the cross-sectional area of the bond points (as measured as the area of the bond point(s) at the surface of the substrate) is in the range of 0.2 to 5% of the overall area of the first layer (as measured at the surface of the substrate). In other exemplary embodiments, the cross-sectional area of the bond points is in the range of 0.5 to 3% of the overall area of the first layer. Of course, it should be understood that the cross-sectional area of the bond points, relative to the cross-sectional area of the first layer, are a function of the design of the work piece and the parameters needed to deliver a desired residual stress pattern and make removal of the piece easier. Thus, other embodiments of the present invention can be outside of the ranges set forth above.

In exemplary embodiments of the present invention, the substrate can be made of any known materials to which the work piece can be bonded as described herein.

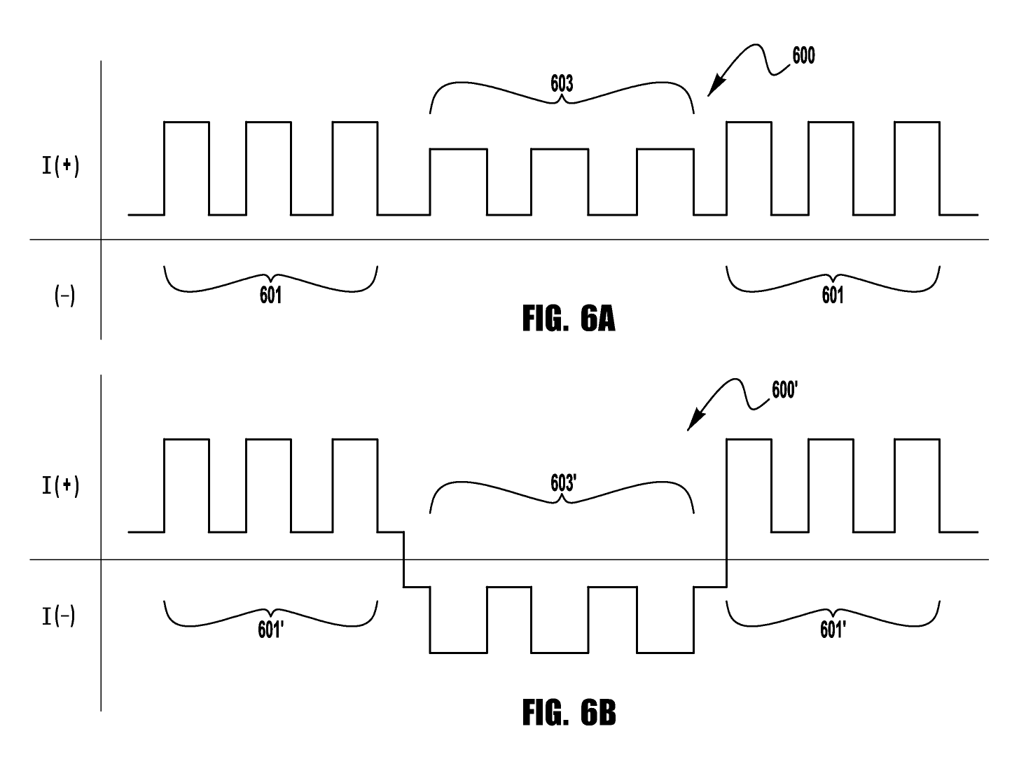

FIGS. 6A and 6B depict exemplary current waveforms 600 and 600′ that can be used with exemplary embodiments of the present invention. Each of the waveforms shown are pulse welding waveforms, but any other types of known welding waveforms can be used. For example, constant current, constant voltage, STT, short arc welding, etc. can be used to achieve the deposition/bonding that is desired. In fact, in some exemplary embodiments of the present invention, the waveform type used to create the first layer can change along the deposition of the first layer. In FIG. 6A the total waveform 600 has a first portion 601 which is used to create bond point. This portion 601 has a plurality of pulses which have a current level which is higher than that of a second portion 603, which is used to create the deposition bead of the first layer. In this embodiment, a second bond point portion 601 is present to create a second bond point in the first layer. In such embodiments, the wire feed speed during the bond point portions 601 is higher than that during the deposition bead portion 603. Of course other parameters, such as voltage, frequency, etc., can be different between waveform portions as well. FIG. 6B depicts a similar waveform 600′ which bond point portions 601′. However, in this embodiment the deposition bead portion 603′ is shown using a negative polarity.

The above discussed waveform embodiments are exemplary and embodiments of the present are not limited to the waveforms shown. In fact, in some exemplary embodiments of the present invention, the bond point portions (601/601′) of the waveforms can use a first deposition waveform type (e.g., pulse, AC, DC, short arc, STT, etc.) while the deposition portion of the waveform (603/603′) can use a different type of welding waveform (e.g., another of pulse, AC, DC, short arc, STT, etc.). Any combination of waveform types can be used, so long as the bond point portions are capable of penetrating the substrate and bonding the first layer to the substrate, and the deposition bead portion does not result in the deposited material to bond to the substrate.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. An additive manufacturing system, comprising:
a power supply which generates a current output signal to generate an arc used to deposit a consumable onto a surface of substrate to create a workpiece made from said consumable; and
a controller coupled to said power supply which controls said power supply such that said current output signal has at least a first portion and a second portion, where said first portion causes said arc to penetrate said surface so as to create at least one bond point between said workpiece and said substrate, and where said second portion causes said consumable to be deposited onto said surface of said substrate without causing said arc to penetrate said surface,
wherein said controller further controls said power supply and a deposition of said consumable such that residual stresses are created within said workpiece during deposition of said consumable and said residual stresses are oriented in a predetermined orientation to impart a force on said at least one bond point.

2. The additive manufacturing system of claim 1, further comprising a motion control device which is controlled by said controller and moves at least one of the consumable and the substrate to cause the consumable to be deposited in a desired pattern during each of said first and second portions of said current waveform.

3. The additive manufacturing system of claim 1, wherein said power supply is a metal inert gas arc welding power supply.

4. The additive manufacturing system of claim 1, wherein said first portion of said waveform has a first average heat input level and said second portion of said waveform has a second average heat input level which is less than said first average heat input level.

5. The additive manufacturing system of claim 4, wherein said second average heat input level is in the range of 7 to 30% lower than the first average heat input level.

6. The additive manufacturing system of claim 4, wherein said second average heat input level is in the range of 10 to 20% lower than the first average heat input level.

7. The additive manufacturing system of claim 1, wherein said power supply generates a third portion of said waveform where said third portion causes said consumable to be deposited onto said surface of said substrate without causing said arc to penetrate said surface, and said third portion has an average heat input which is different than an average heat input of said second portion.

8. The additive manufacturing system of claim 1, wherein said residual stresses are oriented such that a gap is created between said deposited consumable and said surface in a region of said substrate where said second portion of said waveform was used.

9. The additive manufacturing system of claim 1, wherein said power supply generates a third portion of said waveform which is used to deposit said consumable onto a previously deposited layer of said consumable.

10. The additive manufacturing system of claim 9, wherein said third portion has an average heat input which is substantially the same as an average heat input for said first portion.

11. The additive manufacturing system of claim 1, wherein said force is a moment force.

12. An additive manufacturing system, comprising:
a power supply which generates a current output signal to generate an arc used to deposit a consumable onto a surface of substrate to create a workpiece made from said consumable;
a motion control device which moves at least one of the consumable and the substrate to cause the consumable to be deposited in a desired pattern during each of said first and second portions of said current waveform; and
a controller coupled to said power supply and said motion control device which controls said power supply such that said current output signal has at least a first portion and a second portion, where said first portion causes said arc to penetrate said surface so as to create at least one bond point between said workpiece and said substrate, and where said second portion causes said consumable to be deposited onto said surface of said substrate without causing said arc to penetrate said surface, and
where said motion control devices deposits said consumable in said desired pattern, wherein said controller further controls said power supply and said motion control device such that residual stresses are created within said workpiece during deposition of said consumable and said residual stresses are oriented in a predetermined orientation to impart a force on said at least one bond point, and
wherein said first portion of said waveform has a first average heat input level and said second portion of said waveform has a second average heat input level which is less than said first average heat input level.

13. The additive manufacturing system of claim 12, wherein said power supply is a metal inert gas arc welding power supply.

14. The additive manufacturing system of claim 12, wherein said second average heat input level is in the range of 7 to 30% lower than the first average heat input level.

15. The additive manufacturing system of claim 12, wherein said power supply generates a third portion of said waveform where said third portion causes said consumable to be deposited onto said surface of said substrate without causing said arc to penetrate said surface, and said third portion has an average heat input which is different than an average heat input of said second portion.

16. The additive manufacturing system of claim 12, wherein said residual stresses are oriented such that a gap is created between said deposited consumable and said surface in a region of said substrate where said second portion of said waveform was used.

17. The additive manufacturing system of claim 12, wherein said power supply generates a third portion of said waveform which is used to deposit said consumable onto a previously deposited layer of said consumable.

18. The additive manufacturing system of claim 17, wherein said third portion has an average heat input which is substantially the same as an average heat input for said first portion.

19. The additive manufacturing system of claim 12, wherein said force is a moment force.

20. An method of additive manufacturing, comprising:
generating a current output signal with a power supply to create an arc used to deposit a consumable onto a surface of substrate to create a workpiece made from said consumable;
directing said consumable toward said substrate;
moving said consumable in a desired pattern to create said workpiece;
controlling said power supply such that said current output signal has at least a first portion and a second portion, where said first portion causes said arc to penetrate said surface so as to create at least one bond point between said workpiece and said substrate, and where said second portion causes said consumable to be deposited onto said surface of said substrate without causing said arc to penetrate said surface, and
further controlling said power supply and said movement of said consumable such that residual stresses are created within said workpiece during deposition of said consumable and said residual stresses are oriented in a predetermined orientation to impart a force on said at least one bond point.
